(19) United States
(12) Patent Application Publication
(10) Pub. No.: US 2024/0400833 A1
(43) Pub. Date: Dec. 5, 2024

(54) BITUMEN BASE COMPOSITION FOR PRODUCING BITUMEN COMPRISING A PLASTICS LIQUEFACTION OIL

(71) Applicant: TotalEnergies OneTech, COURBEVOIE (FR)

(72) Inventors: Carine BOULANGER, Courbevoie (FR); Mersaka BENKHALED, Courbevoie (FR); Alexandrine CHOFFAT, Courbevoie (FR)

(73) Assignee: TotalEnergies OneTech, COURBEVOIE (FR)

(21) Appl. No.: 18/292,719

(22) PCT Filed: Jul. 25, 2022
(86) PCT No.: PCT/EP2022/070795

§ 371 Date: Aug. 15, 2024

(30) Foreign Application Priority Data
Jul. 26, 2021 (EP) 21306036.1

(51) Int. Cl. C08L 95/00

(52) U.S. Cl. CPC C08L 95/00; C08L 2555/60

(57) ABSTRACT

A bitumen base composition having at least from 95 to 99% by weight at least one bitumen base having a penetrability at 25° C. of less than or equal to 220·10⁻¹ mm and a softening point higher than or equal to 35° C., and from 1 to 5% by weight at least one plastic liquefaction oil the initial boiling point of which is at least 300° C. measured in accordance with D7169:20. The bitumen base composition makes it possible to reprocess a heavy plastic liquefaction oil cut for use in a road bitumen.

### TECHNICAL FIELD

The present invention relates to the field of bitumens, in particular intended for road construction or for civil engineering.

The present invention relates to a composition of bitumen bases comprising a first bitumen base and an oil resulting from the pyrolysis of plastic or from the hydrothermal liquefaction of plastic the initial boiling point of which is at least 300° C., and the method of preparing same.

Another object of the present invention is the use of a plastic liquefaction oil, and in particular of a plastic pyrolysis oil, in a bitumen.

### PRIOR ART

Bitumen is the main hydrocarbon constituent used in the field of road construction or civil engineering. A bitumen can be defined as being a mixture of several “bitumen bases”. Two or more bitumen bases can be mixed to form a composition of bitumen bases. A composition of bitumen bases can form a bitumen. Two or more compositions of bitumen bases can also be mixed to obtain a bitumen.

In order to produce “bitumen bases”, so-called “bitumen-containing” crudes are normally selected according to their suitability for producing said bases. Thus, among all the crude oils referenced, only less than 10% make it possible to produce “bitumen bases”. Said bases are generally obtained from residues resulting from the atmospheric and/or vacuum distillation of crude oil. The main criteria of choice of bitumen crudes are:
The technical characteristics of the bitumen bases coming from these crudes: penetrability, viscosity, softening point (RBT), etc.
Appropriateness for the refinery units, in particular yields with respect to the cutting temperatures of the vacuum distillations.

Producing bitumens from bitumen crudes thus requires making the units operate for a given duration and to adapt them to these particular crudes, which increases the operational costs.

Using additives in bitumen bases is also known, the objective then being able to adapt the technical characteristics of the bitumen bases. However, these additives increase the cost of producing the bitumen bases.

To be able to be used in the field of road construction or civil engineering, bitumens must have certain physicochemical properties. One of the most important properties is the RBT variation; this must be sufficiently small to avoid premature aging of the bitumen.

There are several means considered to be expensive for adjusting the RBT of a bitumen:
A first means is to blow the bitumen. The main objective of blowing a bitumen is to reduce its thermal susceptibility, i.e. to increase the penetrability index (or Pfeiffer index) of the blown bitumen compared with the starting bitumen. The effect of the blowing operation is to harden the bitumen treated by oxidation. A blown bitumen has a ring and ball softening temperature (RBT) higher than that of the starting bitumen and a needle penetrability (P25) of the same order of magnitude of that of the starting bitumen. For the record, the higher the needle penetrability of a bitumen, the better is its handleability and the easier it is to use. In addition, the risks of forming ruts at the service temperature of a given bitumen are lower when the RBT of the bitumen increases.
Blown bitumens are manufactured in a blowing unit, causing a flow of air and/or of oxygen to pass through a bitumen that it is wished to harden. This operation can be implemented in the presence of an oxidation catalyst, for example polyphosphoric acid. Generally, the blowing is implemented at high temperatures, of the order of 200 to 300° C., for relatively long periods typically between 30 minutes and 2 hours, continuously or in batch. This blowing method has a certain number of drawbacks:
   Manufacturing blown bitumen requires a blowing plant especially provided for this purpose,
   Blown bitumens are more sensitive to aging than the starting bitumens,
   Moreover, blown bitumens are generally more fragile when cold than the starting bitumen. This can be explained by the fact that the effect of the blowing is to harden the bitumen.
A second means is to use polymers which, added to the bitumen bases, will modify the properties thereof. Nevertheless, adding these polymers gives rise to additional costs.

### DESCRIPTION OF THE INVENTION

There is therefore a need for a bitumen base composition having advantageous RBT characteristics available at less cost.

Reprocessing plastic waste by using it as an initial feedstock in chemical processes (gasification, pyrolysis, hydrothermal liquefaction, depolymerization, dissolution) or in mechanical processes (grinding) is known. In the initial feedstock, the plastic waste may also be associated with waste originating from biomass.

High-temperature pyrolysis methods or hydrothermal liquefaction methods make it possible to transform plastic waste into several products in variable proportions according to the nature of the waste used: an oil, a gaseous mixture, coke.

The oil originating from the pyrolysis of plastic or from hydrothermal liquefaction can then be separated into several cuts for all types of separation method known per se:
Light cut of the naphtha type with a distillation range of between 50 and 200° C. and a density of between 720 Kg/m³ and 750 Kg/m³.
Medium cut of the diesel type with a distillation range of between 200° C. and 300° C. and a density of between 750 Kg/m³ and 800 Kg/m³.
Heavy cut of the VGO (vacuum gas oil) type with a distillation range of between 300° C. and 450° C. and a density of between 800 Kg/m³ and 840 Kg/m³.
A very heavy cut of the VR (viscoreduced) type with an initial boiling point of at least 450° C. and a density of between 840 Kg/m³ and 870 Kg/m³.

Only the light cut of the naphtha type can be used as a petrochemical base in a steam-cracking feedstock. Heavy cuts of the VGO type and very heavy cuts of the VR type cannot be used as they stand as steam-cracking feedstocks. There is therefore an alternative need for reprocessing heavy to very heavy cuts.

The article “Analysis of possible use of pyrolytic products as binder in asphalt mixes”, published on 10 Apr. 2016 in Gradevinar, mentions mixtures containing 90% bitumen and 10% pyrolysis oil and the RBT softening point of which is similar to that of bitumen alone.

The document WO 2019/109093 describes a method for modifying an asphalt using a fraction of a tire pyrolysis oil having a reduced proportion of aromatic polycyclic hydrocarbons. This document describes modifying an asphalt by adding thereto 0.5 to 30% w/w tire pyrolysis oil for obtaining 100 ppm or less of aromatic polycyclic hydrocarbons and having a solids content of less than 5% w/w. The effect on the aging presented in this document relates to compositions mixing from 1.9 to 7.4% solids originating from the pyrolysis of tires, from 2.3 to 9% tire pyrolysis oil, the remaining consisting of an asphalt.

However, it has been discovered unexpectedly that incorporating plastic liquefaction oil, and in particular plastic pyrolysis oil, the initial boiling point of which measured in accordance with ASTM D7169:20 is at least 300° makes it possible to produce compositions of bitumen bases and therefore bitumens, in particular road bitumens, having improved properties in terms of RBT variation. This improvement has the advantage of avoiding premature aging of the bitumen by incorporating plastic liquefaction oil, in particular plastic pyrolysis oil, the initial boiling point of which is at least 300° C. Furthermore, such incorporation makes it possible to reprocess heavy cuts the initial boiling point of which is at least 300° C. and which cannot easily be reprocessed.

Thus the use of plastic liquefaction oil, and in particular plastic pyrolysis oil, the initial boiling point of which is at least 300° C. as a component of a bitumen, makes it possible to obtain a property particularly sought in a composition of bitumen bases: RBT variation. More precisely, the use of plastic liquefaction oil, and in particular plastic pyrolysis oil, makes it possible to reduce the variation in the softening point of a bitumen base aged in accordance with the RTFOT test of EN 12607-1. This reduction in the variation in the softening point, also expressed as the gain in softening point with respect to the bitumen base alone, can be from 10 to 30%, in particular from 10 to 25%, particularly from 13 to 22%.

This effect is obtained without having to purify the plastic liquefaction oil: all the components of a plastic liquefaction oil the initial boiling point of which is at least 300° C. can be used.

In order to facilitate understanding, the following terms will be defined:

Bitumen base or base: According to the invention, it is considered that a bitumen base or base is the product originating from a refining method (atmospheric distillation, vacuum distillation, etc.). It is a non-finished product in that several bitumen bases are mixed to form a bitumen.

Usually, a bitumen base can be produced by refining a crude oil, in particular a bitumen crude, that is heated to 300° C., partially vaporized in a furnace and transferred into an atmospheric distillation column in which the separation of the various fractions takes place. The lightest vaporize while the heaviest (atmospheric residue) remain at the column bottom and pass into a second heat exchanger before treatment in a vacuum distillation column. Finally, the bitumen base is recovered at the bottom of this vacuum distillation column. The bitumen base corresponds for example to the 560° C.+ cut of the vacuum distillation.

So as to adjust the properties of these bases, supplementary methods can be used (blowing, deasphalting, etc.).

Several bitumen bases treated or not after vacuum distillation are normally mixed to form a bitumen with the required properties such as hardness.

Bituminous binder or bitumen: This term defines a finished product that is a mixture of several bitumen bases. This mixture of several bitumen bases makes it possible to formulate a bituminous binder in order to obtain the required properties relating to a particular use.

Categorization of road bitumens: Depending on their properties and according to standardized measurements, it is possible to classify road bitumens into six groups of road applications:
Category 1—So-called pure bitumens, i.e. not modified by additives or polymers. They are used for the construction and maintenance of road carriageways or surfaced carriageways. By way of example, the grades belonging to this category 1 are grades 20/30, 35/50, 50/70, 70/100 and 160/220, classified according to their penetrability at 25° C. (measured in accordance with the EN 1426:2018 method) and their RBT softening points (EN 1427:2018), respectively 55-63, 50-58, 46-54, 43-51 and 35/43. These grades correspond for example to the grades of the bitumens subject to the specifications of NF EN 12591:2009. A bitumen of grade X/Y has a penetrability at 25° C. of X·10⁻¹ to Y·10⁻¹ mm.
Category 2—Hard-grade road bitumens. By way of example, the grades belonging to this category 2 are the grades 10/20, 15/25 and 5/15 classified according to their penetrability at 25° C. (in accordance with the EN 1426:2018 method) and their RBT softening points (EN 1427:2018), respectively 58-78, 55-71, 60-76. These grades correspond for example to the grades of the bitumens subject to the specifications of NF EN 12594:2014.
Category 3—Multigrade 2 road bitumens. By way of example, the grades belonging to this category 3 are the grades 20/30, 35/50, 50/70, classified according to their penetrability at 25° C. (in accordance with EN 1426:2018) and their RBT softening points (EN 1427:2018), respectively 54-63, 57-66, 63-72. These grades correspond for example to the grades of the bitumens subject to the specifications of NF EN 12594:2014.
Category 4—Bitumens modified by polymers. These bitumens are for example subject to the specifications of NF EN 14023:2010.
Category 5—Cationic emulsions of bituminous binders. These emulsions are for example subject to the specifications of NF EN 13808:2013.
Category 6—Fluxed or fluidified bitumens. These bitumens are for example subject to the specifications of NF EN 15322:2013.

### Plastic Liquefaction Oil:

“Liquefaction oil” means an oil originating from a process of pyrolysis and/or from a process of hydrothermal liquefaction of a hydrocarbon feedstock. This hydrocarbon feedstock can comprise plastics, and optionally biomass, in particular in the form of waste. A liquefaction oil can be formed from a mixture of two or more liquefaction oils originating from the liquefaction of different hydrocarbon feedstocks (plastic waste and biomass).

### Plastic Pyrolysis Oil:

The terms “plastic pyrolysis oil” or “plastic pyrolysis oil” can be used indifferently and refer to the liquid products obtained once the plastic waste has been thermally pyrolyzed. The pyrolysis method must be understood as a non-selective thermal cracking method. Pyrolysis involves breaking the polymer chains by heating at moderate temperatures (approximately 400 to 600° C.). Rather than decomposing the polymer into its original monomers, pyrolysis has a tendency to produce a range of shorter-chain compounds, similar in many regards to the mixtures of hydrocarbons present in crude oil and petroleum products. A catalyst is sometimes used for reducing the operating temperature. The plastic to be pyrolyzed may be of any type. For example, the plastic to be pyrolyzed may be polyethylene, polypropylene, polystyrene, polyesters, polyamides, polycarbonates, etc. The plastic pyrolysis oil typically contains paraffins, i-paraffins (isoparaffins), dienes, alkynes, olefins, naphthenes and aromatic components. The plastic pyrolysis oil may also contain impurities such as organic chlorides, organic compounds of silicon, metals, salts, sulfur and nitrogen compounds, etc. The origin of the plastic leading to the plastic pyrolysis oil is plastic waste without any limitation on the origin or on the nature of the plastic. The composition of the plastic pyrolysis oil depends on the type of plastic pyrolyzed. It however mainly consists of hydrocarbons having from 1 to 50, or even from 1 to 150, carbon atoms and impurities, at more than 90% by weight for example. In the initial feedstock, the plastic waste may also be associated with waste originating from biomass. The proportion of biomass in the initial feedstock may be between 0 and 20% by weight. The oil resulting from the plastic pyrolysis may thus contain biomass.

During pyrolysis, the solid plastics pass through a melting, decomposition, and volatilization phase. The vapors condense to form a liquid product and gases. The condensation may take place at several temperature levels since several liquid cuts or waxes may be distilled according to their boiling points.

### Hydrothermal Liquefaction Oil:

A hydrothermal liquefaction oil refers to the liquid products obtained by a thermochemical conversion method using water as solvent, reagent, and catalyst for the reactions of degradation of a hydrocarbon feedstock, the water typically being in a subcritical or supercritical state. The hydrothermal liquefaction method is typically implemented at a temperature from 250 to 500° C. and at pressures of 10 to 25-40 MPa in the presence of water.

An oil from plastic via hydrothermal liquefaction results from the treatment of any type of plastic, in particular those cited for the plastic pyrolysis oil. In the initial feedstock, the plastic waste may also be associated with waste originating from biomass. The proportion of biomass in the initial feedstock may be between 0 to 20% by weight. The oil resulting from the hydrothermal liquefaction plastic may thus contain biomass.

The composition of an oil from plastic via hydrothermal liquefaction is similar to that of a pyrolysis oil.

The term “boiling point” used refers to the boiling point generally used in the petroleum and gas industry. The boiling points are measured at atmospheric pressure. The initial boiling point is defined as the value of the temperature when the first vapor bubble is formed. The final boiling point is the highest temperature that can be reached during a standard distillation. At this temperature, no further vapor can be entrained in the condensation units. Determination of the initial and final boiling point is known per se. Depending on the boiling range of the mixture, they can be determined by means of various standardized methods such as for example ASTM D2887:2019 relating to the distribution of the boiling range of the petroleum cuts by gas chromatography. For the compositions containing heavier hydrocarbons, the ASTM D7169:2020 or D2892-20:2020 standards can also be used. The boiling ranges of the distillates can also be advantageously measured by means of ASTM D7500:2019.

### DETAILED DESCRIPTION OF THE INVENTION

Other advantages and features will emerge more clearly from the following description, wherein the particular embodiments of the invention are given by way of non-limitative examples.

The present invention consists in proposing a bitumen base composition comprising a conventional bitumen base a) (other than a plastic pyrolysis oil and/or other than a hydrothermal plastic liquefaction oil) the initial boiling point of which is at least 300° C.) mixed with at least one plastic liquefaction oil b) the initial boiling point of which is at least 300° C. measured in accordance with D7169:20.

The plastic liquefaction oil may be a plastic pyrolysis oil, an oil from plastic via hydrothermal liquefaction or a mixture of the two, in particular a plastic pyrolysis oil.

### Bitumen Base Used in the Present Invention

According to the invention, said at least one bitumen base defined at a) has a penetrability at 25° C. measured in accordance with EN 1426:2018 of less than or equal to 220·10⁻¹ mm and a softening point measured in accordance with EN 1427:2018 higher than or equal to 35° C.

This bitumen base may be a conventional bitumen base produced by refining a so-called “bitumen” crude oil, as previously described. Bitumen crudes are heavy crudes the “bitumen” part of which constitutes the densest and most viscous part. Bitumen crudes may come from Venezuela (Boscan, Bachaquero, Lagunillas and Tia Juana) or from the Middle-East (Safaniya (or Arabic heavy) and Kuwait). In other words, said at least one bitumen base defined at a) can be a base resulting from atmospheric distillation and/or vacuum distillation of crude oil, in particular a so-called “bitumen” crude.

Advantageously and non-limitatively, the composition of bitumen bases according to the invention may comprise one or more of the following characteristics:
at least one bitumen base defined at a) having a penetrability at 25° C. of less than or equal to 100·10⁻¹ mm and a softening point higher than or equal to 43° C.,
at least one bitumen base defined at a) having a penetrability at 25° C. of less than or equal to 50·10⁻¹ mm and a softening point higher than or equal to 50° C.

Said at least one bitumen base defined at a) may have a penetrability at 25° C. measured in accordance with EN 1426:2018 of between 5·10⁻¹ to 220·10⁻¹ mm, advantageously from 10·10⁻¹ to 100·10⁻¹ mm or from 35·10⁻¹ to 100·10⁻¹ mm, for example from 5·10⁻¹ to 15·10⁻¹ mm, for example from 15·10⁻¹ to 25·10⁻¹ mm, for example from 10·10⁻¹ to 25·10⁻¹ mm, for example from 20·10⁻¹ to 30·10⁻¹ mm, for example from 35·10⁻¹ to 50·10⁻¹ mm, for example from 50·10⁻¹ to 70·10⁻¹ mm, for example from 70·10⁻¹ to 100·10⁻¹ mm, for example from 160·10⁻¹ to 220·10⁻¹ mm.

Whatever its penetrability, said at least one bitumen base defined at a) may have a softening point measured in accordance with EN 1427:2018 higher than or equal to 35° C. or 43° C. or 50° C., for example from 35° C. to 43° C., for example from 43° C. to 51° C., for example from 46° C. to 54° C., for example from 50 to 58° C., for example from 55° C. to 63° C.

In particular, the softening point may be from 60° C. to 78° C., for example from 58° C. to 78° C. or from 55° C. to 71° C. or from 60° C. to 76° C.

In particular, the softening point may be from 35° C. to 63° C., for example from 35° C. to 43° C. or from 43° C. to 51° C. or from 46° C. to 54° C., or from 50° C. to 58° C. or from 55° C. or 63° C.

In particular, said at least one bitumen base defined at a) may have one of the following groups of characteristics:
a penetrability at 25° C. of 20·10⁻¹ to 220·10⁻¹ mm and a softening point higher than or equal to 35° C., for example from 35° C. to 63° C.
a penetrability at 25° C. of 5·10⁻¹ to 25·10⁻¹ mm and a softening point higher than or equal to 55° C., for example from 55° C. to 78° C.
a penetrability at 25° C. of 20·10⁻¹ to 70·10⁻¹ mm and a softening point higher than or equal to 54° C., for example from 54° C. to 72° C.

By way of example, said at least one bitumen base defined at a) may have one of the following groups of characteristics:
a penetrability at 25° C. of 15·10⁻¹ to 25·10⁻¹ mm and a softening point higher than or equal to 55° C., for example from 55° C. to 71° C.,
a penetrability at 25° C. of 10·10⁻¹ to 20·10⁻¹ mm and a softening point higher than or equal to 58° C., for example from 58° C. to 78° C.,
a penetrability at 25° C. of 5·10⁻¹ to 15·10⁻¹ mm and a softening point higher than or equal to 60° C., for example from 60° C. to 76° C.,
a penetrability at 25° C. of 20·10⁻¹ to 30·10⁻¹ mm and a softening point higher than or equal to 54° C., for example from 54° C. to 63° C.,
a penetrability at 25° C. of 35·10⁻¹ to 50·10⁻¹ mm and a softening point higher than or equal to 57° C., for example from 57° C. to 66° C.,
a penetrability at 25° C. of 50·10⁻¹ to 70·10⁻¹ mm and a softening point higher than or equal to 63° C., for example from 63° C. to 72° C.,
a penetrability at 25° C. of 20·10⁻¹ to 30·10⁻¹ mm and a softening point higher than or equal to 55° C., for example from 55° C. to 63° C.,
a penetrability at 25° C. of 35·10⁻¹ to 50·10⁻¹ mm and a softening point higher than or equal to 50° C., for example from 50° C. to 58° C.,
a penetrability at 25° C. of 50·10⁻¹ to 70·10⁻¹ mm and a softening point higher than or equal to 46° C., for example from 46° C. to 54° C.,
a penetrability at 25° C. of 70·10⁻¹ to 100·10⁻¹ mm and a softening point higher than or equal to 43° C., for example from 43° C. to 51° C.,
a penetrability at 25° C. of 160·10⁻¹ to 220·10⁻¹ mm and a softening point higher than or equal to 35° C., for example from 35° C. to 43° C.,

Said at least one bitumen base defined at a) may in particular belong to one of the bitumen categories 1 to 6 defined above.

### Plastic Liquefaction Oil Used in the Present Invention

Typically, said at least one plastic liquefaction oil defined at b) originates from a method for liquefying plastic, for example a hydrothermal liquefaction method or a pyrolysis method, preferably a pyrolysis method.

The method for producing plastic pyrolysis oils and therefore pyrolysis of plastic waste is described for example in the patents U.S. Pat. No. 8,895,790, US 2014/0228606 or WO 2016/009333.

The mixed plastics (for example the plastic waste) are placed in a pyrolysis unit also referred to as a pyrolyzer. In the pyrolysis unit, the plastic waste is converted by pyrolysis into a pyrolysis product, the pyrolysis product comprising a gaseous phase (for example pyrolysis gases, such as mainly C1 to C4 gases, hydrogen (H₂), carbon monoxide (CO), carbon (CO₂)) and a liquid phase designated as plastic pyrolysis oil. The plastic waste may comprise post-consumption plastic waste, such as mixed plastic waste. Mixed plastics may comprise non-chlorinated plastics (for example polyolefins, polyethylene, polypropylene, polystyrene, copolymers, etc.), chlorinated plastics (for example polyvinylchloride (PVC), polyvinylidine chloride (PVDC), etc.), and the like, or mixtures thereof. Generally, the plastic waste comprises long-chain molecules or polymer hydrocarbons. The plastic waste may also include worn tires or biomass.

The pyrolysis unit may be any suitable reactor configured to convert the plastic waste into products in gaseous phase and in liquid phase (for example simultaneously). The reactor may be configured for operation in a gaseous phase, in liquid phase, in vapor-liquid phase, in gas-solid phase, in liquid-solid phase or in suspension phase. The reactor may contain one or more beds of inert material or pyrolysis catalyst comprising sand, zeolite, alumina, a catalytic cracking catalyst, or combinations Generally, the pyrolysis catalyst is capable of transferring heat to the components subjected to the pyrolysis process in the pyrolysis unit. Alternatively, the pyrolysis unit may operate without any catalyst (for example pure thermal pyrolysis). The pyrolysis unit may operate adiabatically, isothermally, non-adiabatically, non-isothermally, or combinations thereof. The pyrolysis reactions may be implemented in a single step or in several steps. For example, the pyrolysis unit may consist of two reactors connected in series.

In a configuration where the pyrolysis unit comprises two reactors, the pyrolysis method can be divided into a first step that is implemented in a first reactor and a second step fluidically connected downstream of the first step that is implemented in the second reactor.

In some configurations, the pyrolysis unit may comprise one or more items of equipment configured to convert mixed plastic materials into products forming a gaseous phase and into liquid phase. The item or items of equipment may contain or not an inert material or a pyrolysis catalyst as described above. Examples of such items of equipment comprise one or more heated extruders, heated rotary furnace, reactors of the heated reservoir type, lined-bed reactors, boiling fluidized-bed reactors, circulating fluidized-bed reactors, empty heated vessels, closed heated surfaces where the plastic flows along the wall and cracks, receptacles surrounded by furnaces, or any other suitable equipment offering a heated surface for assisting cracking.

The pyrolysis unit can be configured to pyrolyze (for example, crack), and, in some aspects (for example when hydrogen is added to the pyrolysis unit), to hydrogenate the components of the flow of plastic waste supplying the pyrolysis unit. Examples of reactions that can occur in the pyrolysis unit comprise, non-limitatively, isomerization of one or more normal paraffins into one or more isoparaffins, selective opening of the ring of one or more cycloparaffins into one or more isoparaffins, cracking of long-chain molecules into short-chain molecules, eliminating heteroatoms from the hydrocarbons containing heteroatoms (for example dechlorination), hydrogenation of the coke generated in the method, or combinations thereof.

In one or more configurations of the pyrolysis unit, a gas for purging the head space can be used in all or some of the pyrolysis stages (conversion of the plastic waste into products forming a liquid phase and/or a gaseous phase) to improve the cracking of the plastics, to produce value products or to provide a supply for steam cracking, or combinations thereof. The head-space purge gas may comprise hydrogen (H₂), C1 to C4 hydrocarbon gases (for example alkanes, methane, ethane, propane, butane, isobutane), inert gases (for example nitrogen (N₂), argon, helium, steam), or combinations thereof. Using a head-space purge gas assists dechlorination in the pyrolysis unit, when the plastic waste comprises chlorinated plastics. The head-space purge gas can be introduced into the pyrolysis unit to facilitate the elimination of the volatile materials entrained by the molten mixed plastics present in the pyrolysis unit.

A flow containing hydrogen (H₂) can be added to the pyrolysis unit to enrich the environment of the pyrolysis unit with H₂ and thus assist in eliminating the hydrogen chloride trapped in the pyrolysis unit and to provide a local environment rich in hydrogen in the molten mass or the pyrolysis liquid, or combinations thereof; for example via a flow containing H₂ supplied directly to the pyrolysis unit independently of the flow of plastic waste. In some aspects, H₂ can also be introduced with the flow into the pyrolysis unit, with suitable safety measures related to the manipulation of hydrogen with a plastic-material feedstock.

The pyrolysis unit can facilitate any reaction of the components of the flow of plastic waste in the presence of or with hydrogen. Reactions may occur, such as adding hydrogen atoms with double bonds of unsaturated molecules (for example olefins), entraining saturated molecules (for example paraffins, isoparaffins, naphthenes). In addition or in a variant, the reactions in the pyrolysis unit may cause breaking of a bond of an organic compound, with a subsequent reaction and/or replacement of a heteroatom by hydrogen.

Using hydrogen in the pyrolysis unit may have beneficial effects on i) reducing the coke resulting from the cracking, ii) maintaining the catalyst used (where applicable) in the method in an active state, iii) improving the elimination of chloride from the flow so that the pyrolysis product of the pyrolysis unit is substantially dechlorinated with respect to the flow of plastic waste, which minimizes the requirements to eliminate chlorides in the units downstream of the pyrolysis unit, iv) hydrogenation of the olefins, v) reducing diolefins in the pyrolysis product, vi) assisting the operation of the pyrolysis unit at reduced temperatures for the same levels of conversion of the flow of plastic waste in the pyrolysis unit, or combinations of i) to vi).

The pyrolysis methods in the pyrolysis unit may be of low severity or high severity. The low-severity pyrolysis methods may occur at a temperature of below approximately 450° C., preferably from 250° C. to 450° C., preferably from 275° C. to 425° C., or preferably from 300° C. to 400° C., and can produce a pyrolysis oil rich in monoolefins and diolefins, for example at least 15% by weight, as well as a large quantity of aromatics, for example at least 10% by weight. The high-severity pyrolysis methods can occur at a temperature equal to or greater than approximately 450° C., preferably from 450° C. to 750° C., preferably from 500° C. to 700° C., or preferably from 550° C. to 650° C., and can produce a pyrolysis oil rich in aromatics, as well as more gaseous products (compared with low-severity pyrolysis).

A pyrolysis product can be recovered as effluent from the pyrolysis unit and conveyed (for example flowed, for example by pumping, gravity, pressure difference, etc.) to a separation unit. The pyrolysis product can be separated in the separation unit into a pyrolysis gas flow and a pyrolysis plastic oil. The separation unit can comprise any suitable gas-liquid separator, such as a vapor-liquid separator, oil-gas separators, gas-liquid separators, degassers, purifiers, traps, flash vessels, compressor suction vessels, gravity separators, centrifugal separators, filter-blade separators, anti-mist buffers, liquid-gas coalescers, distillation columns and the like, or combinations thereof.

Thus the oil originating from the pyrolysis of the plastic obtained as described above can be separated into several cuts:
Light cut of the naphtha type with a distillation range of between 5° and 200° C. and a density of between 720 Kg/m³ and 750 Kg/m³.
Medium cut of the diesel type with a distillation range of between 200° C. and 300° C. and a density of between 750 Kg/m³ and 800 Kg/m³.
Heavy cut of the VGO (vacuum gas oil) type with a distillation range of between 300° C. and 450° C. and a density of between 800 Kg/m³ and 840 Kg/m³.
A very heavy cut of the VR (viscoreduced) type with an initial boiling point of at least 450° C. and a density of between 840 Kg/m³ and 870 Kg/m³.

Alternatively, the plastic waste can be treated in a hydrothermal liquefaction unit to obtain an oil from plastic via hydrothermal liquefaction that can then be separated into several cuts, as described above.

The plastic liquefaction oil b) according to the invention (obtained by pyrolysis or hydrothermal liquefaction) and the initial boiling point of which is at least 300° C. measured in accordance with D7169:20 is typically obtained by distillation and is therefore generally free from solids.

The plastic liquefaction oil b) according to the invention the initial boiling point of which is at least 300° C. measured in accordance with D7169:20 can originate from a plastic pyrolysis oil obtained by a plastic pyrolysis method as described previously and/or from an oil from plastic hydrothermal liquefaction obtained by a hydrothermal liquefaction method as previously described.

Advantageously and non-limitatively, the plastic liquefaction oil, and in particular the plastic pyrolysis oil, can have an initial boiling point of at least 370° C. measured in accordance with D7169:20.

Advantageously and non-limitatively, the plastic liquefaction oil, and in particular the plastic pyrolysis oil, can have an initial boiling point of at least 390° C. measured in accordance with D7169:20.

Advantageously and non-limitatively, the plastic liquefaction oil, and in particular the plastic pyrolysis oil, can have an initial boiling point of at least 450° C. measured in accordance with D7169:20.

### Composition According to the Invention

According to the invention, a composition of bitumen bases is prepared comprising at least:
a. from 95 to 99% by weight of at least one bitumen base having a penetrability at 25° C. measured in accordance with EN 1426:2018 of less than or equal to 220·10⁻¹ mm and a softening point measured in accordance with EN 1427:2018 higher than or equal to 35° C.,
b. from 1 to 5% by weight of at least one plastic liquefaction oil, and in particular of at least one plastic pyrolysis oil, the initial boiling point is at least 300° C. measured in accordance with D7169:20.

Advantageously and non-limitatively, the composition of bitumen bases according to the invention can comprise at least:
a) from 98 to 99% by weight of at least one bitumen base as defined at a),
b) from 1 to 2% by weight of at least one plastic liquefaction oil, and in particular of at least one plastic pyrolysis oil, as defined at b).

Generally, the at least one base defined at a) and the at least one plastic liquefaction oil, and in particular the at least one pyrolysis oil, defined at b) can each have one of the characteristics or groups of characteristics defined previously.

Advantageously, the composition of bitumen bases can comprise from 1 to 5% by weight, for example from 1 to 2% by weight, of at least one plastic liquefaction oil, and in particular of at least one plastic pyrolysis oil, the initial boiling point of which is at least 300° C. measured in accordance with D7169:20.

The sum of the mass percentages of the bitumen bases defined at a) and b) can be equal to 100%. In other words, the composition of bitumen bases according to the invention can consist of one or more bitumen bases as defined at a) and of one or more plastic liquefaction oils, and in particular of one of more plastic pyrolysis oils, as defined at b). In particular, the composition of bitumen bases according to the invention can consist of a single bitumen base as defined at a) and of a single plastic liquefaction oil, and in particular of a single plastic pyrolysis oil, as defined at b). Furthermore, the composition of bitumen bases according to the invention does not comprise an added third solid component.

Thus the composition of bitumen bases according to the invention can have a solid content of less than 1.9% by mass, in particular less than 1.5% by mass, preferably less than 1% by mass, and more preferably less than 0.5% by mass, more preferentially less than 0.1% by mass. Preferably, the composition according to the invention does not contain solids.

The bitumen base composition according to the invention can be produced by simple mixing of the bitumen bases defined at a) and b), in particular under stirring, at a sufficient temperature to ensure homogeneous mixing of these bases. This temperature is generally 70° C. higher than the softening point of each of the bases (bitumen base and plastic pyrolysis oil).

Provision can be made for preheating each base separately or not, optionally at different temperatures, before proceeding with the mixing. This preheating can be implemented for a sufficient period for the temperature of the base to be homogeneous.

The bitumen base defined at b) can be preheated for at least 2 hours at a temperature of less than 120° C. to avoid the formation of sediments.

In this way a composition of bitumen bases is obtained wherein the variation in the softening point is less than the variation in the softening point of component a) following aging in accordance with the RTFOT test of NF EN 12607-1 [2014]. In particular, this variation can be less than 10 to 30%, in particular 10 to 25%, in particular 13 to 22%.

The invention also relates to the use of a plastic liquefaction oil, and in particular a plastic pyrolysis oil, having an initial boiling point of at least 300° C. measured in accordance with D7169:20 as a component for road bitumen. This use makes it possible to reduce the variation in the softening point of a bitumen base aged in accordance with the RTFOT test of EN 12607-1.

The invention relates in particular to the use of a plastic liquefaction oil, and in particular of a plastic pyrolysis oil, having an initial boiling point of at least 300° C., preferably at least 370° C., preferably at least 400° C., preferably at least 450° C., originating from a plastic liquefaction method, and in particular from a plastic pyrolysis method, as a component for road bitumen.

Several plastic liquefaction oils, in particular several plastic pyrolysis oils, the initial boiling point of which is at least 300° C., can also be used. The liquefaction oil, in particular the pyrolysis oil, can be as previously defined.

As previously defined, this plastic liquefaction oil, and in particular this plastic pyrolysis oil, then forms a bitumen base that can be used for producing a road bitumen.

It is thus possible to manufacture a bitumen base, in particular a road bitumen base, by mixing at least one plastic liquefaction oil, and in particular at least one plastic pyrolysis oil, as previously defined, with at least one bitumen base, as previously defined, in the proportions specified for the composition according to the invention.

### Examples

For the record, throughout the present application, the following properties of the bases are measured as indicated in table 1 below:

TABLE 1

| | | | Measurement |
|---|---|---|---|
| Property | Abbreviation | Unit | standard |
| Needle penetrability | P25 | 1/10 mm | EN 1426: 2018 |
| at 25° C. | | | |
| Ring and ball | RBT | ° C | EN 1427: 2018 |
| softening | | | (with use of liquids |
| temperature | | | for bath which may |
| | | | be distilled or |
| | | | demineralized water |
| | | | or glycerol) |
| FRAASS | Fraass | ° C | EN12593: 2015 |
| breaking point | | | |
| Kinematic viscosity | VD35 | mm²/s | EN12595: 2014 |
| at 135° C. | | | |
| Dynamic viscosity | VD60 | Pa · s | EN12596: 2014 |
| at 60° C. | | | |
| Pfeiffer index | PI | none | EN 12591: 2009 |
| Density at 25° C. | D | Kg/m³ | ASTM D4052: 2018 |
| Kinematic viscosity | VD90 | mm²/s | EN 12595: 2014 |
| at 90° C. | | | |

Four bitumen bases corresponding to base a) according to the invention were used. They were obtained in accordance with methods well known per se and as described previously. The characteristics thereof are present in table 2 below.

TABLE 2

| | Base A | Base C | Base E | Base D |
|---|---|---|---|---|
| | Grade | Grade | Grade | Grade |
| Characteristics | 70/100 | 35/50 | 35/50 | 35/50 |

New binder

| | | | | |
|---|---|---|---|---|
| P25 | 84 | 40 | 40 | 36 |
| RBT | 46.2 | 51.2 | 51.4 | 53.4 |
| Fraass | 0.2 | −10 | −8 | NM |
| PI | −0.9 | −1.4 | −1.3 | −1.1 |

Characteristics
Binder aged according to RTFOT EN 12607-1 [2014]

| | | | | |
|---|---|---|---|---|
| P25 | 50 | 24 | 24 | 22 |
| RBT | 50.8 | 61.2 | 60.6 | 59.8 |
| Variation in RBT | 4.6 | 10 | 9.2 | 6.4 |

Two plastic pyrolysis oils corresponding to base b) according to the invention were used. They were obtained in accordance with the methods well known per se and as previously. Their characteristics are 5 described presented in table 3 below.

TABLE 3

| | Component B: | Component F: |
|---|---|---|
| | plastic pyrolysis oil | plastic pyrolysis oil |
| | having an initial boiling | having an initial boiling |
| | point of 450° C. measured | point of 370° C. measured |
| | in accordance with ASTM | in accordance with ASTM |
| Characteristics | D7169: 20 | D7169: 20 |
| Density 15° C. | 848.1 | 827.5 |
| VD 90 | 14.09 | 4.837 |
| P25 | 96 | 90 |
| RBT | 74 (in glycerol) | 52.2 |
| Fraass | NM | NM |
| PI | −0.8 | 0.9 |

NM: not measured

Before the mixing, the base a) according to the invention is preheated in a ventilated stove at 130° C. The duration of preheating is estimated at 1.5 hours. Base b) according to the invention was preheated for 2 hours at a low temperature of 110° C. to avoid the formation of sediments.

The mixture is heated by an open “flask heater” system with electric element, thermostat and thermocoupled PT100 temperature sensor. Stirring is implemented by a system of the “Rayneri” type, which is a metal centripetal turbine coupled to a stirring system.

The mixture is heated at 160° C. under stirring (250-300 rev/min) for a period of 30 minutes so as to obtain a homogeneous mixture.

Penetrability, RBT and FRAASS measurements are implemented on each of the mixtures in accordance with standardized methods. The characteristics of the mixtures are presented in tables 4 and 5 below.

TABLE 4
Mixtures produced with base A grade 70/100

| | 100% base | Mixture 1: | Mixture 6: |
|---|---|---|---|
| | A Grade | 95% base A | 99.5% base A |
| | 70/100 | and 5% base B | and 0.5% base F |
| Characteristics | | | |
| New binder | | | |
| P25 | 84 | 87 | 129 |
| RBT | 46.2 | 50 | 44.6 |
| Fraass | 0.2 | NM | −15 |
| PI | −0.9 | 0.2 | −0.1 |
| Characteristics | | | |
| Binder aged in | | | |
| accordance with | | | |
| RTFOT EN12607-1 | | | |
| [2014] | | | |
| P25 | 50 | 57 | 72 |
| RBT | 50.8 | 53.8 | 48.2 |
| Variation in RBT | 4.6 | 3.8 | 3.6 |

TABLE 5
Mixtures produced with bases C, D and E grade 35/50

| | 100% | Mixture 2: | Mixture 3: | | Mixture 4: | | Mixture 5: |
|---|---|---|---|---|---|---|---|
| | base C | 99% base | 98% base | 100% | 99.5% base | 100% | 99% base |
| Characteristics | Grade | C and 1% | C and 2% | base | E and 0.5% | base | D and 1% |
| New binder | 35/50 | base B | base B | E | base B | D | base B |
| P25 | 40 | 38 | 43 | 40 | 38 | 36 | 50 |
| RBT | 51.2 | 51.4 | 50.2 | 51.4 | 51.2 | 53.4 | 50 |
| Fraass | −10 | NM | −10 | −8 | −10 | NM | NM |
| PI | −1.4 | −1.4 | −1.5 | −1.3 | −1.5 | −1.1 | −1.2 |
| Characteristics | | | | | | | |
| Binder aged | | | | | | | |
| according to | | | | | | | |
| RTFOT EN12607-1 | | | | | | | |
| [2014] | | | | | | | |
| P25 | 24 | NM | 25 | 24 | 23 | 22 | 30 |
| RBT | 61.2 | 59.8 | 58 | 60.6 | 59.2 | 59.8 | 55 |
| Variation in | 10 | 8.4 | 7.8 | 9.2 | 8 | 6.4 | 5 |
| RBT | | | | | | | |

For mixtures 1 to 6, an improvement is observed in the RBT properties after RTFOT aging (NF EN 12607-1 [2014]).This is because the variation in RBT is smaller for mixtures 1 to 6 compared with bases a) alone. This effect is particularly interesting since the RBT is a limiting constraint in the formulation of a bitumen in accordance with the specification EN 12591:2009.

Furthermore, mixtures 1 to 5 show that it is possible to incorporate a plastic pyrolysis oil B with an initial boiling point of 450° C. without degrading the properties of the bitumen. Mixtures 1, 3, 4 and 5 have properties in accordance with the obligatory properties expected by the specification EN 12591 both with regard to penetrability at 25° C. and the softening point (RBT).

Without being bound by any theory, the plastic pyrolysis oil b) with an initial boiling point of 450° C. (base B) or the plastic pyrolysis oil with an initial boiling point of 370° C. (base F) may provide a reserve with respect to the specification of RBT variations, i.e. a gain in RBT, which can be assimilated to a booster effect. The results are set out in table 6 below.

The plastic pyrolysis oils B and F according to b) can also be mixed with each other before being incorporated in a bitumen base.

The incorporation can thus be envisaged to the extent of 5% (by weight).

TABLE 6

| | Variation in RBT after | Gain in RBT after |
|---|---|---|
| | aging with respect to | aging with respect to |
| | the base alone | the base alone |
| Mixture 1 - 5% | 0.8 | 17% |
| pyrolysis oil B | | |
| Mixture 2 - 1% | 1.6 | 16% |
| pyrolysis oil B | | |
| Mixture 3 - 2% | 2.2 | 22% |
| pyrolysis oil B | | |
| Mixture 4 - 0.5% | 1.2 | 13% |
| pyrolysis oil B | | |
| Mixture 5 - 1% | 1.4 | 22% |
| pyrolysis oil B | | |
| Mixture 6 - 5% | 1 | 22% |
| pyrolysis oil F | | |

1. A method for preparing a composition of bitumen bases wherein the following are mixed:
a. from 95 to 99% by weight of at least one bitumen base conforming to the specifications of NF EN 12591:2009 and having a penetrability at 25° C. measured in accordance with EN 1426:2018 of less than or equal to 220·10⁻¹ mm and a softening point measured in accordance with EN 1427:2018 higher than or equal to 35° C.,
b. from 1 to 5% by weight at least one plastic pyrolysis oil the initial boiling point of which is at least 300° C. measured in accordance with D7169:20,
and a composition of bitumen bases is obtained wherein the variation in the softening point is less than the variation in the softening point of component a) following aging in accordance with the RTFOT test of NF EN 12607-1 [2014].

2. The method for preparing a composition of bitumen bases according to claim 1, wherein the following are mixed:
from 98 to 99% by weight of at least one bitumen base as defined at a)
from 1 to 2% by weight of at least one plastic pyrolysis oil as defined in b).

3. The method for preparing a composition of bitumen bases according to claim 1, wherein said at least one bitumen base defined at a) is a base resulting from the atmospheric distillation and/or vacuum distillation of crude oil.

4. The method for preparing a composition of bitumen bases according to claim 1, wherein said at least one plastic pyrolysis oil defined at b) originates from a plastic pyrolysis method.

5. The method for preparing a composition of bitumen bases according to claim 1, wherein said at least one bitumen base defined at a) has a penetrability at 25° C. of between 5·10⁻¹ to 220·10⁻¹ mm, for example from 10·10⁻¹ to 100·10⁻¹ mm or from 35·10⁻¹ to 100·10⁻¹ mm.

6. The method for preparing a composition of bitumen bases according to claim 1, wherein said at least one bitumen base defined at a) has a softening point higher than or equal to 43° C.

7. The method for preparing a composition of bitumen bases according to claim 1, wherein said at least one bitumen base defined at a) has a softening point higher than or equal to 50° C.

8. The method for preparing a composition of bitumen bases according to claim 1, wherein at least one plastic pyrolysis oil defined at b) has an initial boiling point of at least 370° C. measured in accordance with D7169:20, preferentially at least 400° C. measured in accordance with D7169:20, preferentially at least 450° C. measured in accordance with D7169:20.

9. The method for preparing a composition of bitumen bases according to claim 1, wherein the variation in the softening point of the composition is less than 10 to 30% of the variation in the softening point of component a).

10. A method of making road bitumen comprising incorporating a plastic liquefaction oil having an initial boiling point of at least 300° C. measured in accordance with D7169:20 as a component for the road bitumen for reducing the variation in the softening point of a bitumen base conforming to the specifications of NF EN 12591:2009 and aged in accordance with the RTFOT test of EN 12607-1 [2014].

11. The method to claim 10, wherein the plastic pyrolysis oil has an initial boiling point of at least 400° C. measured in accordance with D7169:20, preferably at least 450° C. measured in accordance with D7169:20.

12. The method according to claim 10, wherein the following are mixed:
a. from 95 to 99% by weight at least one bitumen base conforming to the specifications of NF EN 12591:2009 and having a penetrability at 25° C. measured in accordance with EN 1426: 2018 of less than or equal to 220·10⁻¹ mm and a softening point measured in accordance with EN 1427:2018 higher than or equal to 35° C.,
b. from 1 to 5% by weight at least one plastic pyrolysis oil the initial boiling point of which is at least 300° C. measured in accordance with D7169:20.

13. The method according to claim 10, wherein the following are mixed:
from 98 to 99% by weight of at least one bitumen base as defined at a)
from 1 to 2% by weight of at least one plastic pyrolysis oil as defined in b).

14. The method according to claim 10, wherein the bitumen base comprises one or more of the following properties:
the bitumen base is a base resulting from the atmospheric distillation and/or vacuum distillation of crude oil,
the bitumen base has a penetrability at 25° C. of between 5·10⁻¹ to 220·10⁻¹ mm, for example from 10·10⁻¹ to 100·10⁻¹ mm or from 35·10⁻¹ to 100·10⁻¹ mm,
the bitumen base has a softening point higher than or equal to 43° C.,
the bitumen base has a softening point higher than or equal to 50° C.

15. The method according to claim 10, wherein the reduction in the variation of the softening point of a bitumen base is from 10 to 30%.
